(19) United States
(12) Patent Application Publication
(10) Pub. No.: US 2002/0173285 A1
(43) Pub. Date: Nov. 21, 2002

(54) Pre-amplification software linearizer

(76) Inventors: Michael S. Davis, Mountain View, CA (US); Alan R. Cherrette, Los Altos, CA (US); Joel Varney, Mountain View, CA (US)

Correspondence Address: Joyce Kosinski, Loral Space and Communications, Ltd., Suite 303, 655 Deep Valley Drive, Rolling Hills Estates, CA, 90274, US

(21) Appl. No.: 09/819,781

(22) Filed: Mar. 28, 2001

(51) Int. Cl. H04B 1/10

(52) U.S. Cl. 455/295; 455/63; 455/114

(57) ABSTRACT

Pre-amplification software-based linearization of a signal that is subsequently distorted by a nonlinear amplifier to produce a signal having reduced intermodulation distortion. The predistortion that reduces the intermodulation distortion is obtained by processing the original signal using an algorithm that is based on the characteristics of the nonlinear amplifier. Exemplary processing apparatus comprises circuitry that digitizing an input signal. A software linearizer processes the digitized signal to produce a pre-distorted RF signal. Circuitry is provided that converts the pre-distorted RF signal to an analog signal. A nonlinear amplifier amplifies the pre-distorted analog signal to produce an output signal corresponding to the input signal that has reduced intermodulation distortion. An exemplary processing method comprises the following steps. An input signal is digitized. The digitized signal is processed to produce a pre-distorted RF signal that is to be subsequently amplified to produce a signal that has reduced intermodulation distortion. The pre-distorted RF signal is converted to an analog signal. The pre-distorted analog signal is amplified to produce an output signal corresponding to the input signal that has reduced intermodulation distortion.

### BACKGROUND

The present invention relates generally to linearization of power amplifiers, and more particularly, to a pre-amplification software-based linearizer and linearization method.

The assignee of the present invention manufactures and deploys spacecraft into geosynchronous and low earth orbits. Such spacecraft carry communication equipment including transponders and power amplifiers. Linearizers have heretofore been developed that attempt to linearize such power amplifiers.

The closest previously known solution implemented by the present invention is a pre-amplification linearizer circuit. In this pre-amplification linearizer technique, the linearizing function is performed just before high power amplification using a circuit designed for that purpose.

Regarding other known linearization techniques, U.S. Pat. No. 5,789,978, issued Aug. 4, 1998, entitled “Ku-Band Linearizer Bridge”, U.S. Pat. No. 5,999,047, issued Dec. 7, 1999, entitled “Linearizer for use with Power Amplifiers”, U.S. Pat. No. 5,966,049, issued Oct. 12, 1999, entitled “Broadband linearizer for power amplifiers”, and U.S. patent application Ser. No. 09/433,128, filed Nov. 3, 1999 entitled “Low Cost Miniature Broadband Linearizer”, all of which are assigned to the assignee of the present invention, disclose various linearizers for use with power amplifiers. In pre-amplification linearizers, the linrearizing function is performed just before high power amplification.

However, there are no known prior art software-based linearizers that are used for pre-amplification linearization. Therefore, it is an objective of the present invention to provide for a pre-amplification software-based linearizer and linearization method.

### SUMMARY OF THE INVENTION

To accomplish the above and other objectives, the present invention provides for pre-amplification software-based linearization of a signal that is distorted by a nonlinear amplifier. The present pre-amplification software linearization technique involves sending a predistorted signal through a nonlinear amplifier, which results in reduced intermodulation distortion. The predistortion that reduces the intermodulation distortion is obtained by applying an algorithm to the original signal. The algorithm is based on the nonlinear amplifier characteristic.

Exemplary processing apparatus comprises circuitry that digitizing an input signal. A software linearizer processes the digitized signal to produce a pre-distorted RF signal that is to be subsequently amplified to produce a signal that has reduced intermodulation distortion. Circuitry is provided that converts the pre-distorted RF signal to an analog signal. A nonlinear amplifier amplifies the pre-distorted analog signal to produce an output signal corresponding to the input signal that has reduced intermodulation distortion.

An exemplary processing method comprises the following steps. An input signal is digitized. The digitized signal is processed to produce a pre-distorted RF signal that is to be subsequently amplified to produce a signal that has reduced intermodulation distortion. The pre-distorted RF signal is converted to an analog signal. The pre-distorted analog signal is amplified to produce an output signal corresponding to the input signal that has reduced intermodulation distortion.

The linearizing function in the pre-amplification software linearizer is performed before high power amplification in software before the signal is D/A converted. The technique can be used in place of prior art techniques at potentially less cost, or can be used to linearize amplifiers that were built without linearizers. An example is linearizing traveling wave tube amplifiers (TWTAs) on satellites from a gateway on the ground.

The present invention greatly reduces intermodulation distortion in transmitted signals while allowing efficient amplifier operation. Reduction in intermodulation distortion provides better signal to noise ratios, which allows increase data rates. Reduction in intermodulation distortion will also allows the use of more bandwidth efficient modulation formats that conserve bandwidth.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 is a block diagram that illustrates signal processing steps that implement exemplary pre-amplification software linearization in accordance with the principles of the present invention using a software linearizer in a gateway for linearizing a nonlinear amplifier in a repeater;

FIG. 2 is a block diagram that illustrates signal processing steps that implement exemplary pre-amplification software linearization in accordance with the principles of the present invention for linearizing a nonlinear user terminal amplifier; and

FIG. 3 is a flow diagram that illustrates an exemplary pre-amplification software linearization method in accordance with the principles of the present invention.

### DETAILED DESCRIPTION

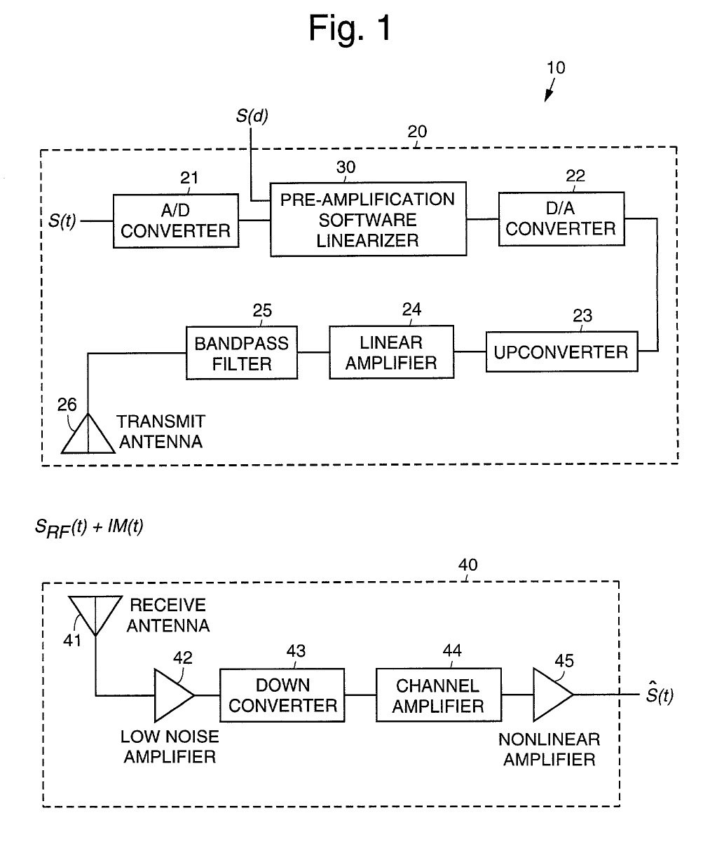

Referring to the drawing figures, FIG. 1 is a block diagram that illustrates a signal processing architecture 10 or apparatus 10 and related signal processing steps that implement pre-amplification software-based linearization in accordance with the principles of the present invention. FIG. 1 shows a pre-amplification software linearizer 30 used in a signal processing architecture 10 comprising a gateway 20 that linearizes a nonlinear amplifier 45 in a repeater 40.

The gateway 20 (or transmitter 20) comprises an analog to digital (A/D) converter 21 that receives a baseband signal, S(t), and digitizes it. The A/D converter 21 is coupled to the pre-amplification software linearizer 30 whose output is converted to an analog signal by a digital to analog (D/A) converter 22. The output of the D/A converter 22 is processed for transmission by an upconverter 23, a linear amplifier 24, a bandpass filter 25, and a transmit antenna 26. The gateway 20 transmits a signal comprising an RF signal and intermodulation distortion, illustrated in FIG. 1 as the signal S_{RF}(t)+IM(t).

The repeater 40 (or receiver 40) comprises a receive antenna 41 that receives the transmitted signal S_{RF}(t)+IM(t) and a processing chain including a low noise amplifier 42, a downconverter 43, a channel amplifier 44 and the nonlinear amplifier 45. The output of the nonlinear amplifier 45 outputs an estimate of S(t) that has reduced intermodulation distortion. The estimate of S(t) is the signal Ŝ(t).

The signal processing steps illustrated in the FIG. 1 are well understood by those skilled in the art. These processing steps involve transmission of the pre-distorted RF signal S_{RF}(t)+IM(t) (generated in the gateway 20) over a free space link to the repeater 40, such as a satellite repeater 40, for example, that amplifies the signal in a nonlinear fashion. The signal after nonlinear amplification by the nonlinear amplifier 45 will have improved NPR relative to a non-predistorted signal at the same power level.

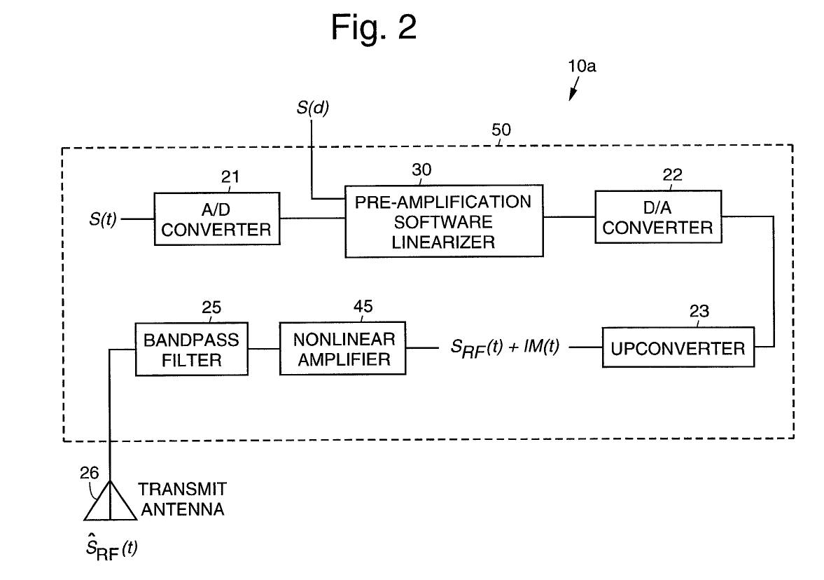

Another example of the use of the present pre-amplification software linearizer 40 is illustrated in FIG. 2. FIG. 2 is a block diagram illustrating a signal processing architecture 10a or apparatus 10a and signal processing steps that implement exemplary pre-amplification software linearization of a nonlinear user terminal amplifier 45. This signal processing architecture 10a is implemented in a user terminal 50, for example.

The user terminal 50 comprises an analog to digital (A/D) converter 21 that receives a baseband signal, S(t), and digitizes it. The A/D converter 21 is coupled to the pre-amplification software linearizer 30 whose output is converted to an analog signal by a digital to analog (D/A) converter 22. The output of the D/A converter 22 is processed by an upconverter 23 that produces a pre-distorted RF signal S_{RF}(t)+IM(t).

The pre-distorted RF signal S_{RF}(t)+IM(t) is input to a nonlinear amplifier 45 whose output is filtered by a bandpass filter 25, and coupled to a transmit antenna 26 for transmission. The signal transmitted by the transmit antenna 26 is a signal Ŝ(t) that has reduced intermodulation distortion.

These processing steps involve generation of a predistorted RF signal, S_{RF}(t)+IM(t), in the user terminal 50 that is passed through a nonlinear transmit amplifier 45 in the user terminal 50. Again, the signal after nonlinear amplification will have improved NPR relative to a non pre-distorted signal at the same power level.

The key to the invention is the pre-amplification software linearizer 30. The signal processing performed by the pre-amplification software linearizer 30 is described in detail below.

Description of the algorithm implemented in the pre-amplification linearizer 30.

The description of the algorithm is divided into two parts. The first part involves characterizing the nonlinear amplifier 45 that is to be linearized. The result of characterizing the nonlinear amplifier 45 is a set of coefficients that are used in the signal processing to create the pre-distorted signal that when passed through the nonlinear amplifier 45 comes out with reduced NPR. The second part of the description involves the signal processing algorithm that creates the pre-distorted signal.

Characterization of the nonlinear amplifier 45.

Amplifier output power (Pₒᵤₜ) versus input power (Pᵢₙ) and output power insertion phase (Phase) versus input power (Pᵢₙ) is measured for a sinusoidal Continuous Wave (CW) signal. The power and phase transfer characteristics are converted into in-phase and quadrature amplitude transfer curves using the equations:

aout=\sqrt{Pout}, (1)

ain=\sqrt{Pin}, (2)

aoutᵢ=aout * cos (Phase), (3)

aoutq=aout* sin (Phase). (4)

An nth-order polynomial is fit to the amplitude transfer curves:

aoutᵢ=b₁_{_{—}}ᵢ·ain+b₃_{_{—}}ᵢ·ain³+b₅_{_{—}}ᵢ·ain⁵+b₇_{_{—}}ᵢ·ain⁷+...+bₙ_{_{—}}ᵢ·ainⁿ (5)

aout_{q}=b₁_{_{—}}_{q}·ain+b₃_{_{—}}_{q}ain³+b₅_{_{—}}_{q}·ain⁵+b₇_{_{—}}_{q}ain⁷ +...+bₙ_{_{—}}_{q}·ainⁿ. (6)

And ain is a function of time.

The resulting constants are converted from the CW curve into a time domain curve by dividing each polynomial coefficient by:

$$w ( i ) = ⌊ \frac{n !}{( \frac{n - 1}{2} ) ! ( \frac{n + 1}{2} ) ! \cdot {2}^{( n - 1 )}} ⌋ \qquad ( 7 )$$

w(1)=1; w(3)=¾; w(5)=⅝; w(7)=35/64; etc. (8)

cᵢ_{_{—}}ₜ=bᵢ_{_{—}}ₜ/1;c₃_{_{—}}ₜ=b₃_{_{—}}ₜ/¾;c₅_{_{—}}ₜ=b₅_{_{—}}ₜ/⅝;c₇_{_{—}}ₜ=b₇_{_{—}}ₜ/35/64; etc. (9)

cᵢ_{_{—}}_{q}=bᵢ_{_{—}}_{q}/1;c₃_{_{—}}_{q}=b₃_{_{—}}_{q}/¾;c₅_{_{—}}_{q}=b₅_{_{—}}_{q}/⅝;c₇_{_{—}}_{q}=b₇_{_{—}}_{q}/35/64; etc. (10)

This gives a new set of constants and polynomials:

aoutᵢ_{_{—}}ₜ=c₁_{_{—}}ᵢ·ain+c₃_{_{—}}ᵢ·ain³+c₅_{_{—}}ᵢ·ain⁵+c₇_{_{—}}ᵢ·ain⁷+...+cₙ_{_{—}}ᵢ·ainⁿ (11)

aout_{q}_{_{—}}ₜ=c₁_{_{—}}_{q}·ain+c₃_{_{—}}_{q}·ain³+c₅_{_{—}}_{q}·ain⁵+c₇_{_{—}}_{q}·ain⁷+...+cₙ_{_{—}}_{q}·ain^{m}. (12)

Each of the in-phase and quadrature coefficients are combined into a set of complex coefficients:

cₙ=cₙ_{_{—}}ᵢ−j·cₙ_{_{—}}_{q} (13)

A new signal is derived that comprises the old signal combined with a perturbation that cancels intermodulation. Let:

Sₒᵤₜ=c₁·Sᵢₙ+c₃·Sᵢₙ³+c₅·Sᵢₙ⁵+...+cn·Sᵢₙⁿ. (14)

Substitute:

Sᵢₙ=Yᵢₙ+d₃·Yᵢₙ³ (15)

into Equation (14), resulting in:

Sₒᵤₜ=c1·(Yᵢₙ+d3·Yᵢₙ³)+c3·(Yᵢₙ+d3·Yᵢₙ³)³+.... (16)

Expanding and collecting terms results in:

Sₒᵤₜ=c1·Yᵢₙ+(c3+c1·d3)·Yᵢₙ³+3·c3·d3·Yᵢₙ⁵++3·c3·d3²·Yᵢₙ⁷+c3·d3³·Yᵢₙ⁹... (17)

Setting:

d3=−c3/c1 (18)

results in:

$${S}_{out} = c1 \cdot {Y}_{in} - \frac{3 \cdot 3 {c}^{2} \cdot {Y}_{in}^{5}}{c1} + \frac{3 \cdot 3 {c}^{3} \cdot {Y}_{in}^{7}}{{c1}^{2}} + \frac{3 \cdot 3 {c}^{4} \cdot {Y}_{in}^{7}}{{c1}^{3}} ⋯ . \qquad ( 19 )$$

Note that the Yᵢₙ³ term has vanished. To find the correct value for d₅, equation (20) is used equation (14):

Sᵢₙ=Yᵢₙ+d₃·Yᵢₙ³+d₅·Yᵢₙ⁵. (20)

the next steps are to expand and collect terms and set the value of d₅ so that all fifth order components of the output signal vanish. Repeat the process with the seventh, ninth and eleventh orders yields the following values:

$$\begin{matrix}{d}_{1} = {c}_{1} & ( 21 ) \\ {d}_{3} = - {c}_{3} / {c}_{1} & ( 22 ) \\ {d}_{5} = \frac{( 3 \cdot {c}_{3}^{2} - {c}_{1} \cdot {c}_{5} )}{{c}_{1}^{2}} & ( 23 ) \\ {d}_{7} = \frac{( - 12 \cdot {c}_{3}^{3} + 8 {c}_{1} \cdot {c}_{3} \cdot c - {c}_{1}^{2} \cdot {c}_{7} )}{{c}_{1}^{3}} & ( 24 ) \\ {d}_{9} = \frac{( 55 \cdot {c}_{3}^{4} - 55 \cdot {c}_{1} \cdot {c}_{3}^{2} \cdot {c}_{5} + 10 \cdot {c}_{1}^{2} \cdot {c}_{3} \cdot {c}_{7} + ( 5 \cdot {c5}^{2} - {c}_{1} \cdot {c}_{9} ) )}{{c}_{1}^{4}} & ( 25 ) \\ {d}_{11} = \frac{\begin{matrix}( - 273 {c}_{3}^{5} + 36 {c}_{1} {c}_{3}^{3} {c}_{5} + 78 {c}_{1}^{2} {c}_{3} ( {c}_{5}^{2} + {c}_{3} {c}_{7} ) + \\ 12 {c}_{1}^{3} ( {c}_{5} {c}_{7} + {c}_{3} {c}_{9} ) - {c}_{1}^{4} {c}_{11} )\end{matrix}}{{c}_{1}^{5}} & ( 26 )\end{matrix}$$

d₁₃+... and so on.

The above “dᵢ” coefficients are used in the pre-amplification linearization algorithm.

Signal processing algorithm.

The noise signal vector N that is to be predistorted is taken from its' source and stored in a variable. Then, the mean of N is subtracted from N:

N=N−mean(N). (27)

The resulting signal is digitally resampled to 4 or 8 times so that future operations will not cause aliasing in the passband. Then the power in the signal is calculated:

$$P = \frac{2 {\sum }_{k = 1}^{m} {N}_{k}^{2}}{m} \qquad ( 28 )$$

where m is the length of the signal.

The signal power is normalized to 1. N is an amplitude signal given by:

N_{normalized}=N/\sqrt{P}. (29)

N is scaled to the required input power; “drive_point” is in dBm:

$${N}_{1} = {N}_{normalized} \sqrt{10 drive\_ po int - \frac{30}{10}} . \qquad ( 30 )$$

Now the signal has the desired amplitude. A fast Fourier transform (FFT) is computed on a copy of the signal:

F₁=fft(N₁). (31)

The signal is shifted 90 degrees by multiplying the first half (positive frequency portion) by −\sqrt{−1}=−j:

$${F}_{Q} = ( 1 : \frac{length ( {F}_{1} )}{2} ) = - j \cdot ( 1 : \frac{length ( {F}_{1} )}{2} ) , \qquad ( 32 )$$

and the second half of the frequency portion by j:

$${F}_{Q} ⌊ \frac{length ( {F}_{1} )}{2} + 1 : length ( {F}_{1} ) ⌋ = j \cdot {F}_{1} ( \frac{length ( {F}_{1} )}{2} + 1 : length ( {F}_{1} ) ) . \qquad ( 33 )$$

Then an inverse FFT is computed to move the signal back to the time domain:

N_{Q}=ifft(F_{Q}). (34)

The quadrature signal and the original (in-phase) signal are passed, point by point, through a perturbation nonlinearity. For the kth time sample point:

In_phaseₖ=real(d₃)·N_{I}_{_{—}}ₖ³+real(d₅)·N_{I}_{_{—}}ₖ⁵+real(d₇)·N_{I}_{_{—}}ₖ⁷+... (35)

Quadratureₖ=imag(d₃)·N_{Q}_{_{—}}ₖ³+imag(d₅)·N_{Q}_{_{—}}ₖ⁵+imag(d₇)·N_{Q}_{_{—}}ₖ⁷+... (36)

The original signal is added to the in-phase and quadrature signals. For the kth time sample point:

Signalₖ=N₁_{_{—}}ₖ+In_phaseₖ+Quadratureₖ. (37)

Finally, the signal is sent through a digital band-pass filter. The resulting signal is ready to be converted to an analog signal and transmitted through the nonlinear amplifier 45. Depending on how linear the amplifier 45 is without this modification, fewer coefficients may be required to effectively linearize the signal. A very linear solid state power amplifier (SSPA), for example, may only require the d₃ component in equations (35) and (36).

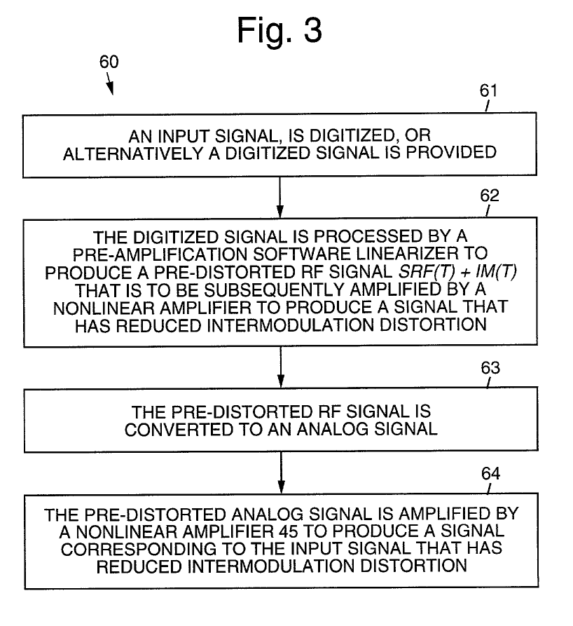

FIG. 3 is a flow diagram that illustrates an exemplary pre-amplification linearization method 60 in accordance with the principles of the present invention. The exemplary pre-amplification linearization method 60 comprises the following steps.

An input signal, S(t), is digitized 61. The digitized signal is processed 62 by a pre-amplification software linearizer 30 to produce a pre-distorted RF signal S_{RF}(t)+IM(t) that is to be subsequently amplified by a nonlinear amplifier 45 to produce a signal that has reduced intermodulation distortion. The pre-distorted RF signal is converted 63 to an analog signal. The pre-distorted analog signal is amplified 64 by a nonlinear amplifier 45 to produce a signal corresponding to the input signal that has reduced intermodulation distortion.

The pre-amplification software linearization implemented by the present invention can reduce intermodulation distortion, which improves Noise Power Ratio (NPR). Preliminary measured results indicate that a transmitted signal with NPR=17.5 dB can be improved to an NPR=20.0 dB by pre-amplification linearization. This increases output power (at 20 dB NPR) by 1.0 dB relative to a solid state power amplifier (SSPA) that is not linearized.

Thus, a pre-amplification linearizer and pre-amplification linearization method have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. Signal processing apparatus comprising:
circuitry for digitizing an input signal;
a software linearizer for processing the digitized signal to produce a pre-distorted RF signal that is to be subsequently amplified to produce a signal that has reduced intermodulation distortion;
circuitry for converting the pre-distorted RF signal to an analog signal; and
a nonlinear amplifier for amplifying the pre-distorted analog signal to produce an output signal corresponding to the input signal that has reduced intermodulation distortion.

2. The apparatus recited in claim 1 further comprising:
an upconverter for upconverting the pre-distorted analog signal;
a linear amplifier for amplifying the pre-distorted signal;
a bandpass filter for filtering the pre-distorted signal; and
a transmit antenna for transmitting the filtered pre-distorted signal

3. The apparatus recited in claim 1 further comprising:
a receive antenna for receiving the pre-distorted signal;
a low noise amplifier for amplifying the received pre-distorted signal;
a downconverter for downconverting the pre-distorted signal; and
a channel amplifier for amplifying the pre-distorted signal and coupling it to the nonlinear amplifier.

4. The apparatus recited in claim 1 further comprising:
an upconverter for upconverting the pre-distorted analog signal and coupling it to the nonlinear amplifier;
a bandpass filter for filtering the output signal having reduced intermodulation distortion; and
a transmit antenna for transmitting the filtered output signal having reduced intermodulation distortion.

5. A pre-amplification linearization method comprising the steps of:
digitizing an input signal;
processing the digitized signal to produce a pre-distorted RF signal that is to be subsequently amplified to produce a signal that has reduced intermodulation distortion;
converting the pre-distorted RF signal to an analog signal; and
amplifying the pre-distorted analog signal to produce an output signal corresponding to the input signal that has reduced intermodulation distortion.

6. The method recited in claim 5 wherein the processing step comprises processing the digitized signal using a pre-amplification software linearizer to produce the pre-distorted RF signal.
